(19) United States
(12) Patent Application Publication
(10) Pub. No.: US 2020/0208810 A1
(43) Pub. Date: Jul. 2, 2020

(54) METHOD FOR MOUNTING A LIGHT MODULE FOR AN ILLUMINATING DEVICE

(71) Applicant: Hella GmbH & Co. KGaA, Lippstadt (DE)

(72) Inventors: David Duhme, Lippetal (DE); Werner Kosters, Lippetal (DE); Stefan Kraus, Dortmund (DE); Thomas Albert Röbbecke, Erwitte (DE); Ralf Seiger, Lippstadt (DE)

(21) Appl. No.: 16/613,595

(22) PCT Filed: May 11, 2018
(86) PCT No.: PCT/EP2018/062231

§ 371 Date: Nov. 14, 2019

(30) Foreign Application Priority Data
May 15, 2017 (DE) 10 2017 110 455.0

(51) Int. Cl. F21V 19/00; F21V 7/04; B29C 65/48; B29C 65/54

(52) U.S. Cl. CPC F21V 19/005; F21V 7/04; B29L 2031/747; B29C 65/542; B29C 65/4845

(57) ABSTRACT

A method is provided for mounting a light module. A light module that is mounted by means of such a method includes at least one light source for emitting light, and at least one optical element for forming the beam of light. The relative arrangement between the light source and the optical element is adjusted via the following steps. The light module is arranged in an adjusting device, and a light detection device is provided. The light source is switched on, and the light detection device is illuminated with the light. A set deviation between a value and an actual value of a light field generated with the light as compared to a required light field is measured. The relative arrangement between the light source and the optical element is then adjusted until the set/actual deviation is minimal or zero.

### CROSS REFERENCE

This application claims priority to PCT Application No. PCT/EP2018/062231, filed 11 May, 2018, which itself claims priority to German Patent Application 10 2017 110455.0, filed May 15, 2017, the entirety of both of which are hereby incorporated by reference.

### FIELD OF THE INVENTION

The present invention relates to a method for mounting a light module and a light module for an illuminating device that is mounted by means of such a method, with at least one light source for emitting light and with at least one optical element for forming the beam of light, where the relative arrangement between the light source and the optical element is adjusted.

### BACKGROUND

A method of mounting a light module with at least one light source and one optical element is known from DE 10 2012 106 313 A1 where the light module can be suitably adjusted by the optical element, represented by a reflector is adjustive relative to the light source. There is no detailed description of any metrological analysis of the deviation between the set position and an actual position of the reflector relative to the semiconductor light source.

A light module is known from DE 10 2015 103 649 A1 by means of which an adjustment method can be implemented in order to modify the relative arrangement between a light source and an optical element implemented as a reflector such that ultimately a required light field can be generated by the light source and the optical element. In this context, the connection between the optical element and the light source comprises mechanical elements that can be adjusted relative to each other.

One disadvantage of this method is that the possibilities for adjustment by means of simple mechanical calibration of the relative arrangement between the light source and the optical element are limited and it is not easily possible to determine a set/actual deviation with the necessary precision. Particularly when the light emitting opening widths of the optical elements become progressively smaller and when the distance between the light source and the optical element is progressively reduced, greater degrees of precision are required in the relative arrangement between the light source and the optical element that require additional mounting methods.

### SUMMARY OF THE INVENTION

The task of the invention is to refine a method for mounting a light module, where the relative arrangement between the light source and the optical element of the light module can be adjusted to the greatest possible degree of precision. In particular, a set/actual deviation of the relative arrangement should be kept to a minimum or as close to zero as possible.

In accordance with the invention, the method provides for at least the following steps: Arrangement of the light module in an adjusting device; provision of a light detection device; switching on the light source and illumination of the light detection device with the light; measuring a set/actual deviation of a light field created with the light to a required light field and adjustment of the relative arrangement between the light source and the optical element until the set/actual deviation is minimal or zero.

The basic concept of the invention is to implement the relative arrangement between the at least one light source and at least one optical element with the assistance of a light detection device, and if the light of at least one light source is switched on, a set/actual deviation between an actual light field and a required light field can be determined. On the basis of this deviation, the adjusting device can be controlled in order to adjust the relative arrangement between the light source and the optical element in such a way that the set/actual deviation is minimal or zero. In this respect, the method includes both the possibility of changing the position of the light source relative to the optical element or changing the position of the optical element relative to the light source. In doing so, the light source and the optical element do not have to be connected directly to each other, and intermediate elements can be provided for that are involved in the connection between the light source and the optical element, such as printed circuit boards, heat sinks or the like.

In particular, it is advantageous when the adjustment of the relative arrangement between the light source and the optical element is implemented by means of a handling device of the adjusting device. In this context, the adjusting device preferentially has the handling device itself and the handling device acts to adjust the relative arrangement between the light source and the optical element. For example, the handling device can comprise a mounting device by means of which the optical element, but also for example the light source, is temporarily mounted until the position of the optical element or the light source is changed until the set/actual deviation between the light source and the optical element is zero.

As a further advantage, a control unit is provided for and the control of the handling device is implemented by means of the control unit, where the set/actual deviation identified by the light detection device is output as input value to the control unit. In this respect, the control unit acts in particular to register the set/actual deviation between a light field currently being generated and a required light field as input value and to convert the same into commands used to control the handling device. The light detection device and/or the control unit can be set up peripherally to the adjusting device, specifically in order to provide for a necessary distance between the light module and the light field received; it is, however, also conceivable that the adjusting device, the control unit and the light detection device are implemented in the form of one assembly. In particular, the handling device is a component of the adjusting device.

As a further step in accordance with the invention, it is intended that a permanent connection be created at least indirectly between the light source and the optical element following adjustment of the relative arrangement between the light source and the optical element. In this respect, the permanent connection can be implemented by mechanical means; in particular, it is of advantage if the permanent connection is produced with an adhesive.

For example, a cavity is provided for this purpose into which an extension extends and the adhesive for producing the permanent connection can be filled into the cavity following adjustment of the relative arrangement between the light source and the optical element, thus forming an interface between the light source and the optical element. For example, the optical element is mounted on a heat sink via a printed circuit board and the extension is located on the heat sink and extends into the cavity. In this respect, the cavity can be introduced into a body on which the optical element is also formed, for example in the form of a reflector. In this respect, there is the alternative of forming the cavity in the heat sink, and the body on which the optical element is formed can comprise the extension. It is advantageous for the cavity to be formed in such a way that when the light module is in clamped state in the adjusting device the adjusting device can be filled into the cavity and also remains in the same due to gravity.

According to a further design of the invention, the adhesive is filled into the cavity through an injection delivery device. For this purpose, the injection delivery device can for example form a tube that is passed temporarily through the heat sink and/or through the extension and/or through the body in order to guide the adhesive through the tube and to fill it into the cavity. For example, the cavity can be introduced into the body that is located below the heat sink to which, in turn, the extension that extends into the cavity is attached. This means that a particular advantage can be obtained from guiding the injection delivery device from above through a channel introduced into the heat sink and that extends into the extension and there being an opening at the end of the extension. If the adhesive is now guided through the tube-like injection delivery device, it can be filled into the cavity in which the adhesive then remains due to gravity, as the cavity only has an opening upwards in the direction of the heat sink. In this way, cavities on the interior can be filled with adhesive that are generally not accessible. In this respect, one material advantage is, in addition, the reliability of the method for feeding in adhesive as no drip mass can arise that would have to be removed.

As a further advantage, the adhesive is photo-curing, specifically UV curing, and once the adhesive has been filled into the cavity it can be irradiated with light in order to trigger and specifically accelerate a curing process of the adhesive. Following curing of the adhesive, the position of the optical element is consequently set relative to the light source and frozen in a specific way so that it will no longer change. The benefit of the adhesive solution can be found in particular in the fact that the adjustment of the relative arrangement between the light source and the optical element can be effected by the handling device without power. In particular, there can be multiple instances of the arrangement of the extension and a cavity filled with glue.

The method furthermore specifies that the light module is removed from the adjusting device once the adhesive has cured and that the light source is put back into operation to illuminate the light detection device with light. In a sense, this provides a check as to whether the light module with the light source and the optical element are mounted correctly such that the set/actual deviation between the light field that can actually be created and the required light field is kept to the absolute minimum or zero, even when the light module is no longer located in the adjusting device.

The invention further addresses a light module that was mounted using the method described above. In this respect, the at least indirect connection between the at least one light source and the optical element has at least one glue joint.

Furthermore, the invention addresses an adjusting device for implementing the method for mounting a light module according to claim 11. In particular, the adjusting device has a handling device for adjusting the relative arrangement between the light source and the optical element.

As a further advantage, the adjusting device has an injection delivery device for feeding in an adhesive for creating a permanent connection between the light source and the optical element, for which purpose the injection delivery device is designed in such a way that it can be passed through the heat sink and/or the extension and/or the body in order to fill the adhesive into the cavity.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 is a schematic view of the arrangement of a light module in an adjusting device with a light module switched on for illuminating a light detection device.

FIG. 2 is a view of the light module in arrangement in the adjusting device, where a gluing joint is produced between the light source and the optical element.

FIG. 3 illustrates the light module removed from the adjusting device with a finished glue joint between the light source and the optical element.

### DETAILED DESCRIPTION OF THE DRAWINGS

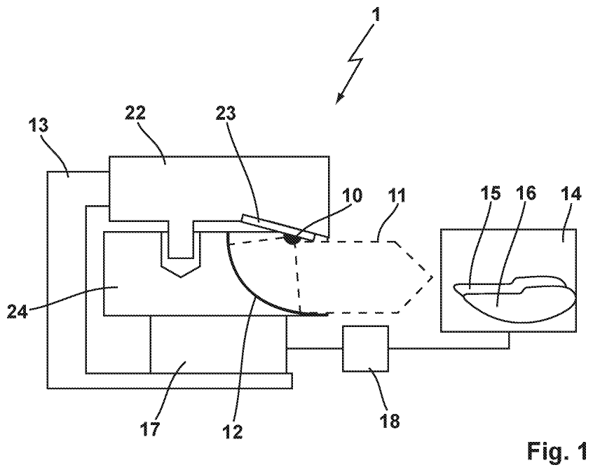

FIG. 1 shows a schematic view of the arrangement of a light module 1 in an adjusting device 13. The light module 1 shows as an example a light source 10 that is being put into operation and is emitting light 11. The light source 10 is mounted on a printed circuit board 23 that is fastened to a heat sink 22. The heat sink 22 is in a fixed arrangement on the arrangement 13.

The optical element 12 is formed by a mirror or a reflector, where the reflector is formed on a body 24. The adjusting device 13 comprises a handling device 17, and the body 24 with the optical element 12 formed as a reflector is arranged on the handling device 17.

The light 11 generated by the light source 10 leaves the light module 1 along a main axis and irradiates a light detection device 14. In doing so, the light 11 generates a current light field 15, and the representation shows, as an example, that the light field 15 currently being generated deviates in its position from a required light field 16. In this respect, a light-dark cut-off line in a setting that is too high is shown as an example.

The light detection device 14 is connected via a control unit 18 with the handling device 17.

If the method for mounting the light module 1 has been completed, the light source 10 is then switched on and thus illumination of the light detection device 14 in which the light field 15 is created. The light detection device 14 is used to measure a set/actual deviation of the light field 15 created with a required light field 16. This measured values are output at the control unit 18. The control unit 18 converts this deviation into commands and transmits them to the handling device 17, that modify the relative position of the body 24 and thus also of the optical element 12 to the light source 10 until the set/actual deviation is minimal or zero. This is effected by the light 11 being varied in its propagation axis until overlapping between the light field 15 actually generated and the required light field 16.

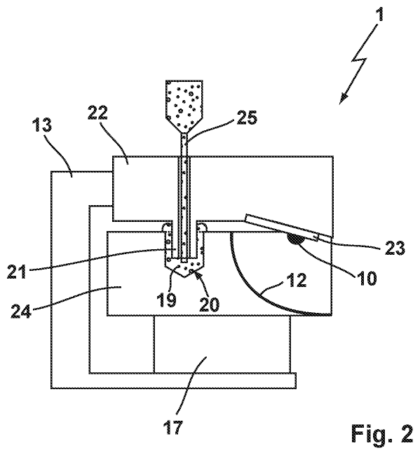

FIG. 2 shows the arrangement of the light module 1 in the adjusting device 13 and the figure shows an extension 21, that is arranged on the heat sink 22, where the light source 10 is fastened to the heat sink 22 via the printed circuit board (23). Consequently, the light source 10 forms a rigid unit together with the extension 21.

The body 24 has a cavity 20 into which the extension 21 of the heat sink 22 extends. The cavity 20 serves to hold an adhesive 19 with which the extension 21 can be glued in the cavity 20. If adjustment of the relative arrangement between the light source 10 and the optical element 12 has been completed, the next step if for the body 24 to be held by the handling device 17 of the adjusting device 13 while the adhesive 19 is filled into the cavity 20 using, for example, an injection delivery device 25. As an advantage, the injection delivery device 25 extends through the extension 21 so that the adhesive 19 can be filled directly into the cavity 20.

Once the adhesive 19 has dried, the heat sink 22 is consequently rigidly arranged in relation to the body 24. Logically, the arrangement of the light source 10 relative to the optical element 12 is also fixed, and the light module 1 can be removed from the adjusting device 13.

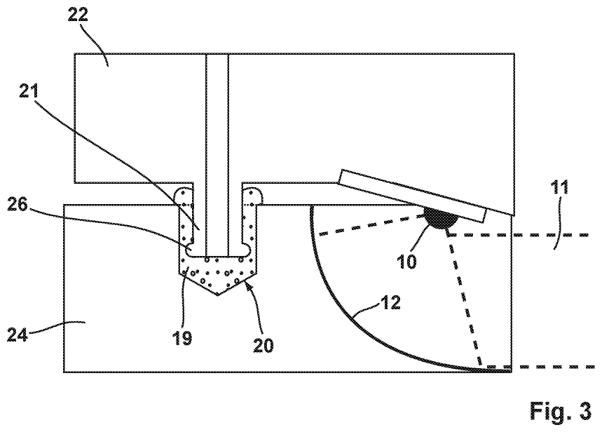

FIG. 3 shows the light module 1 separately, and the adhesive 19 has already solidified so that the heat sink 22 is likewise rigidly arranged relative to the body 24. By putting the light source 10 into operation once again, the light 11 can also be generated when the light module 1 has already been separated, so that a check that the set/actual deviation is kept to an absolute minimum can be performed. In doing so, the light can once again irradiate the light detection device 14 in a manner not shown in more detail. Ultimately, a light module 1 is provided that has at least in an indirect arrangement between the light source 10 and the optical element 12 a glue joint with an adhesive 19, where the light source 10 is adjusted exactly in a set position relatively to the optical element 12. In this respect, the glue joint with the adhesive 19 forms a joint to balance out all the aggregate tolerances especially between the light source 10, the printed circuit board 23, the heat sink 22 and the optical element 12 on the body 24. Irrespective of other tolerances, measurement of the set/actual deviation of the light field generated in comparison to a required light field makes it possible to exactly adjust the light source 10 relative to the optical element 12.

Solidification of the adhesive 19 freezes, as it were, the exact position. The end of the extension 21 that extends into the cavity 20 and thus dips into the adhesive 19 is, according to this version presented, implemented with a bulge 26. This gives rise, in addition to the adhesive effect of the adhesive, a form fit between the extension 21 and the adhesive so that an even greater joint strength can be achieved between the heat sink 22 and the body 24. In particular, there is also the possibility of implementing the cavity 20 with a border running around facing inward in such a way that a form fit is created between the adhesive 19 and the body 24.

The design of the invention is not limited to the preferred embodiment specified here. Rather, a number of variants are conceivable, which make use of the present solution even in designs of a fundamentally different type. All of the features and/or advantages arising from the claims, description or drawings, including design details, physical layout and process steps, may be vital to the invention both by themselves and in a wide variety of combinations.

### LIST OF REFERENCE NUMBERS

1 Light module
10 Lighting products
11 Light
12 Optical element
13 Adjusting device
14 Light detection device
15 Light field
16 Light field
17 Handling device
18 Control unit
19 Adhesive
20 Cavity
21 Extension
22 Heat sink
23 Printed circuit board
24 Body
25 Injection delivery device
26 Bulge

1. A method for mounting a light module, said light module having at least one light source for emitting light, and having at least one optical element for forming the beam of light, where the relative arrangement between the light source and the optical element is adjusted according to at least the following steps:
arranging the light module in an adjusting device,
providing a light detection device,
switching on the light source and illuminating of the light detection device with the light,
measuring a deviation between an actual value of a light field generated with the light as compared to a set value of a required light field and
adjusting the relative arrangement between the light source and the optical element to reduce the deviation.

2. The method in accordance with claim 1, the adjusting of the relative arrangement between the light source and the optical element is implemented by a handling device of the adjusting device.

3. The method in accordance with claim 2, control of the handling device is implemented by a control unit, where the deviation identified by the light detection device is output as an input value to the control unit.

4. The method in accordance with claim 1, wherein following adjustment of the relative arrangement between the light source and the optical element, a permanent connection is created between the light source and the optical element.

5. The method in accordance with claim 4 wherein the permanent connection between the light source and the optical element is created by means of an adhesive.

6. The method in accordance with claim 5, wherein the adhesive is filled into a cavity into which an extension extends, where the cavity and the extension form an interface between the light source and the optical element.

7. The method in accordance with claim 6 wherein the adhesive is filled into the cavity by an injection delivery device.

8. The method in accordance with claim 7, wherein the injection delivery device forms a tube that is passed temporarily through a heat sink and/or through the extension and/or through the body in order to guide the adhesive through the tube and to fill it into the cavity.

9. The method in accordance with claim 6 wherein the adhesive is irradiated with light following filling into the cavity in order to trigger or accelerate a curing process of the adhesive.

10. The method in accordance with claim 9 wherein the light module is removed from the adjusting device once the adhesive has cured and where the light source is put back into operation to illuminate the light detection device with light.

11. A light module, mounted using a method in accordance with claim 1.

12. The light module in accordance with claim 11, wherein the at least indirect connection between the at least one light source and the optical element has a glue joint.

13.-15. (canceled)
